(19) United States
(12) Patent Application Publication
(10) Pub. No.: US 2012/0233043 A1
(43) Pub. Date: Sep. 13, 2012

(54) Mobile Device and Method for Determining a Number of Days Before a Tax Liability Trigger

(76) Inventor: Daniel Goldscheider, Lachen (CH)

(21) Appl. No.: 13/044,266

(22) Filed: Mar. 9, 2011

(51) Int. Cl. G06Q 40/00

(52) U.S. Cl. 705/31

(57) ABSTRACT

The present disclosure relates to a mobile device and method for determining a number of days before a tax liability trigger. In one embodiment, a mobile device receives location information identifying a country that the mobile device is present in and tracks a number of days the mobile device is present in the country. The mobile device determines a number of days before a tax liability trigger occurs in the country based on the tracked number of days and tax information of the user of the mobile device, and then displays the number of days before the tax liability trigger.

### BACKGROUND

Some countries may require an individual to pay certain taxes if the person stays in the country for longer than a set time period. However, the individual may not be aware of local tax laws, which can be very complex. This problem is compounded if the individual travels to many different countries in a tax year given that countries may have different thresholds or even different definitions of what constitutes a day spent in a country from a tax law perspective.

### SUMMARY

The present disclosure relates to a mobile device and method for determining a number of days before a tax liability trigger. In one embodiment, a mobile device receives location information identifying a country that the mobile device is present in and tracks a number of days the mobile device is present in the country. The mobile device then determines a number of days before a tax liability trigger occurs in the country based on the tracked number of days and tax information of the user of the mobile device, and then displays the number of days before the tax liability trigger.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is an illustration of a mobile device of an embodiment with a “Past” option and a “Map” option selected.

FIG. 2 is an illustration of a mobile device of an embodiment with a “Past” option and an “Alphabetical” option selected.

FIG. 3 is an illustration of a mobile device of an embodiment with a “Past” option, an “Alphabetical” option, and a country selected.

FIG. 4 is an illustration of a mobile device of an embodiment with a “Past” option, an “Alphabetical” option, and a consecutive date range selected.

FIG. 5 is an illustration of a mobile device of an embodiment with a “Future” option and a “Map” option selected.

FIG. 6 is an illustration of a mobile device of an embodiment with a “Future” option and a “List” option selected.

FIG. 7 is an illustration of a mobile device of an embodiment with a “Future” option, a “List” option, and a country selected.

FIG. 8 is an illustration of a mobile device of an embodiment with a “Download” option selected.

FIG. 9 is an illustration of a mobile device of an embodiment with a “Settings” option selected.

FIG. 10 is a block diagram of a mobile device of an embodiment.

FIG. 11 is a flowchart of a method of an embodiment for determining a number of days before a tax liability trigger.

### DETAILED DESCRIPTION

The following description is merely exemplary in nature and is not intended to limit the present disclosure, application, or uses.

As used herein, “tax information” is defined as any user information or country information relevant to determining the user's compliance with tax laws of the country. Example of “tax information” include, but are not limited to current tax domicile, previous tax domicile, second tax domicile, employment information, citizenship(s), residence permits, and whether a user is self employed.

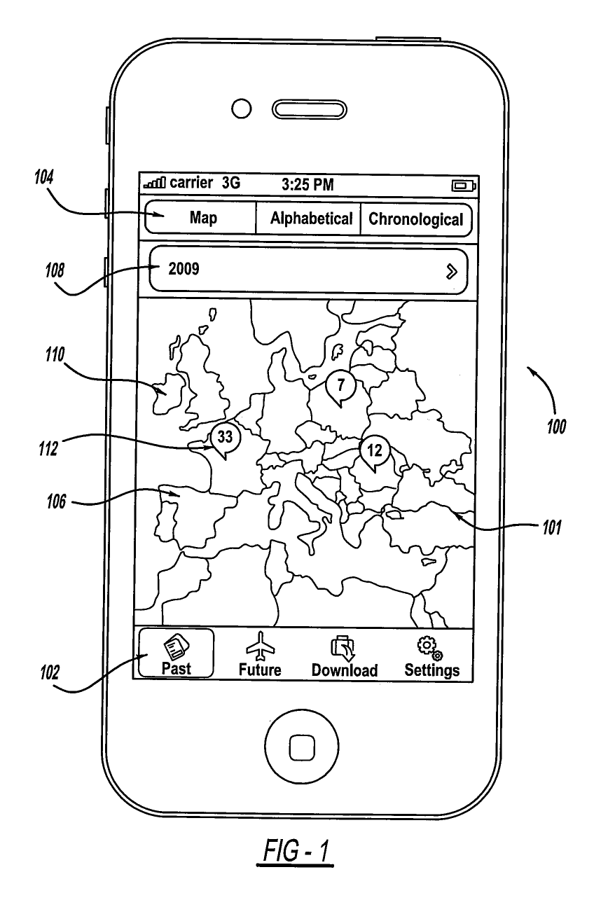

FIGS. 1-9 illustrate an exemplary graphical user interface 100 of a mobile device of an embodiment for determining a number of days before a tax liability trigger. The mobile device may be a cellular phone, a portable personal computer, a telecommunications device, a portable music player, or any other mobile device. The mobile device may have a global positioning system or a user input device for receiving location information identifying a country that the mobile device is present in, or the mobile device may be able to derive its position from mobile phone network information or by multilaterating the position vis-a-vis multiple cell towers.

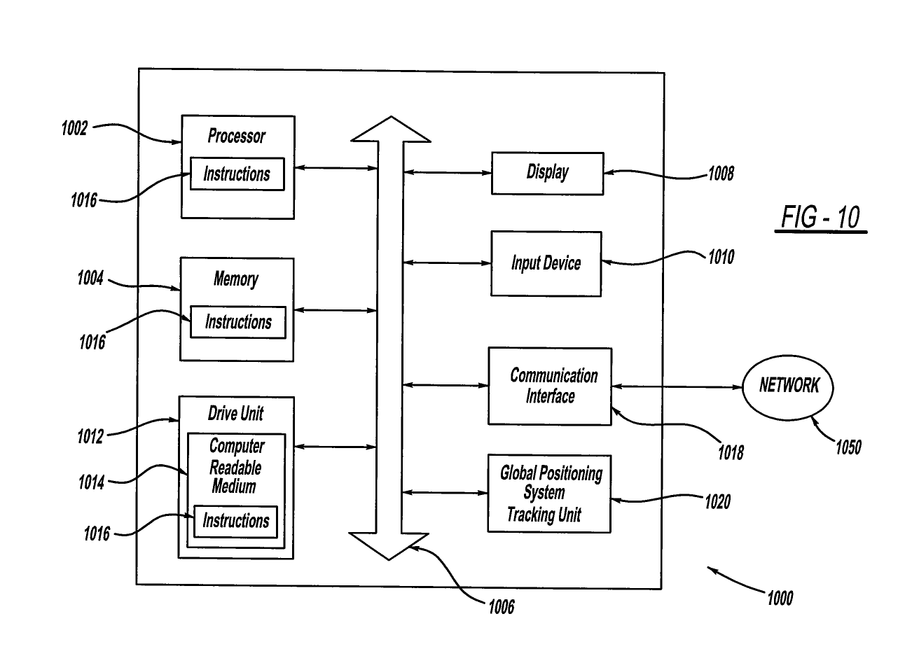

FIG. 10 shows an exemplary block diagram of a mobile device of an embodiment. The functionality discussed below of determining a number of days before a taxable device can be implements in an application (“an app”) of the mobile device. The app can be downloaded to the mobile device ore pre-installed in the mobile device.

FIG. 1 is a screenshot of a page 101 displaying the graphical user interface 100, which includes a menu bar 102, a display options toolbar 104, a year input field 108, and a display area 106 that includes map representations 110 and text boxes 112. The menu bar 102 may include options that a user may select to display different data in the display area 106. For example, the options in the menu bar 102 includes “Past,” “Future,” “Download,” and “Settings.”

As shown in FIG. 1, the “Past” option (i.e. a past view) is selected in the menu bar 102, and the “Map” option is selected in the display options toolbar 104. When the “Past” option is selected in the menu bar 102, the display area 106 displays data representing the number of days the user was located in one or more countries in current and/or previous years (e.g., 2009 in FIG. 1). As a user travels in the one or more countries, the number of days the user was present in each of the one or more countries may be tracked and automatically updated using location information received from the global positioning system. The number of days the user was present in the one or more countries may also be tracked and manually updated using location information received from the user using the user input device. The past view may be useful to the user, as the user may be considered a resident of a country (e.g., the United States) for tax purposes based on the number of days the user was located in the country over a period of time (e.g., a three year period).

For example, under the substantial presence test in the United States, the user may be considered a United States resident for tax purposes if: (1) the user is present in the United States for 31 days during the current year (e.g., 2011); and (2) the user is present in the United States for 183 days during the three-year period that includes the current year and the two years immediately before the current year (e.g., 2009 and 2010). According to the substantial presence test, the number of days the user was located in the country over the three-year period may be calculated by adding (1) the number of days the user was present in the United States in the current year; (2) one-third times the number of days the user was present in the first year before the current year; and (3) one-sixth times the number of days the user was present in the second year before the current year. For example, if the user was present in the United States on 120 days in each of 2009, 2010 and 2011, the user would not be considered a resident of the United States under the substantial presence test for 2011: 120 days for 2011+40 days for 2010 (i.e., ⅓ of 120)+20 days for 2009 (i.e., ⅙ of 120)=180 days. Accordingly, as used herein, the number of days the user was located in the country displayed on the graphical user interface 100 may be equal to either the actual number of days the user was located in the country, or a weighted number of days the user was located in the country according to a country's tax code. The weighting may be according to the United States tax code as above, or any other country's tax code.

In the past view, the graphical user interface 100 includes the year input field 108. The user may input text into the year input field 108 to select a selectable year, or the year input field 108 may be a drop-down menu containing the selectable year, for example. The selectable year may include the (1) current year, (2) the first year before the current year, (3) the second year before the current year, (4) a combination of the first year before the current year and the second year before the current year, (5) a combination of the current year and the first year before the current year, and/or (6) a combination of the current year, the first year before the current year, and the second year before the current year. Using the year input field 108, the user may choose selectable years (e.g., 2009), either by inputting the text or using the drop-down menu, to view in the display area 106 the data representing the number of days the user was located in the one or more countries during the selectable years.

After the user selects one of the selectable years in the input field 108, the selection in the display options toolbar 104 may determine how the data representing the number of days the user was located in the one or more countries is displayed. For example, the options in the display options toolbar 104 may include “Map,” “Alphabetical,” “Chronological,” “List,” or a combination thereof. When the “Map” option is selected in the display options toolbar 104, as shown in FIG. 1, the display area 106 may display the map representation 110 of the one or more countries the user was located in during the selected selectable year and the corresponding data representing the number of days the user was located in the one or more countries (i.e., number of tracked days). The display area 106 may show some or all of the one or more countries the user was located in during the selected selectable year. The display area 106 may show a map of a region (e.g., Europe) of the world or a map of the entire world. In one embodiment, users may be able to zoom in and out of this map to reveal more countries or details. The number of tracked days may be displayed in the display area 106 in text boxes 112 placed in or pointing to the map representations 110 of some or all of the one or more countries. FIG. 1 shows a map representation of part of Europe, as the user was located in France on 33 days, in Romania on 12 days, and in Poland on 7 days in 2009. Tax information relating to the one or more countries may be utilized to adjust the value of the number of tracked days. The tax information may be received from the user via a user input device of the mobile device.

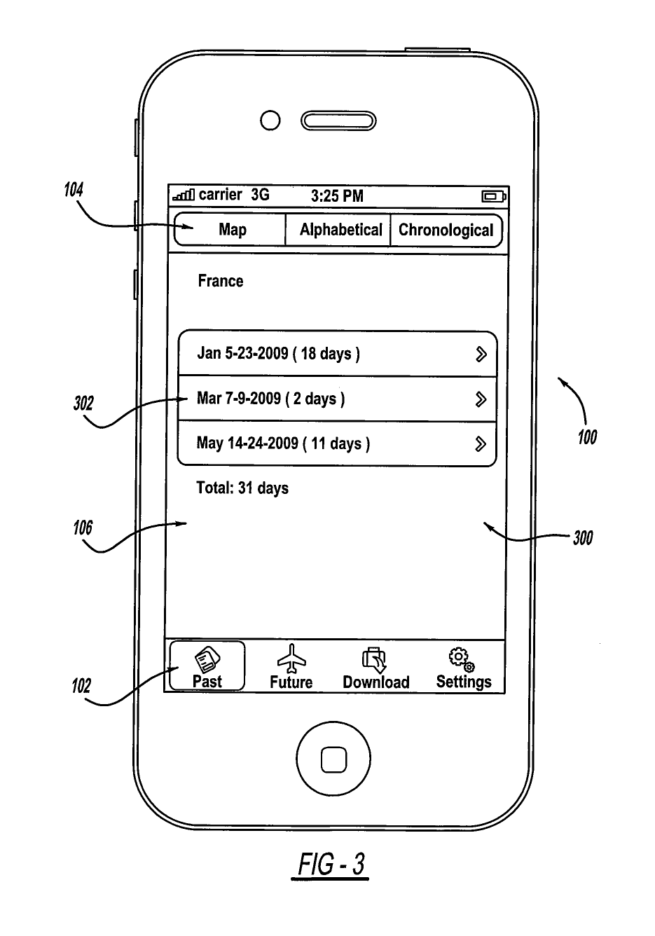

If the “Map” option of the display options toolbar 104 is currently selected, the user may select one of the text boxes 112 corresponding to a country, for example “France,” to display additional number of tracked days, which will be shown in FIG. 3.

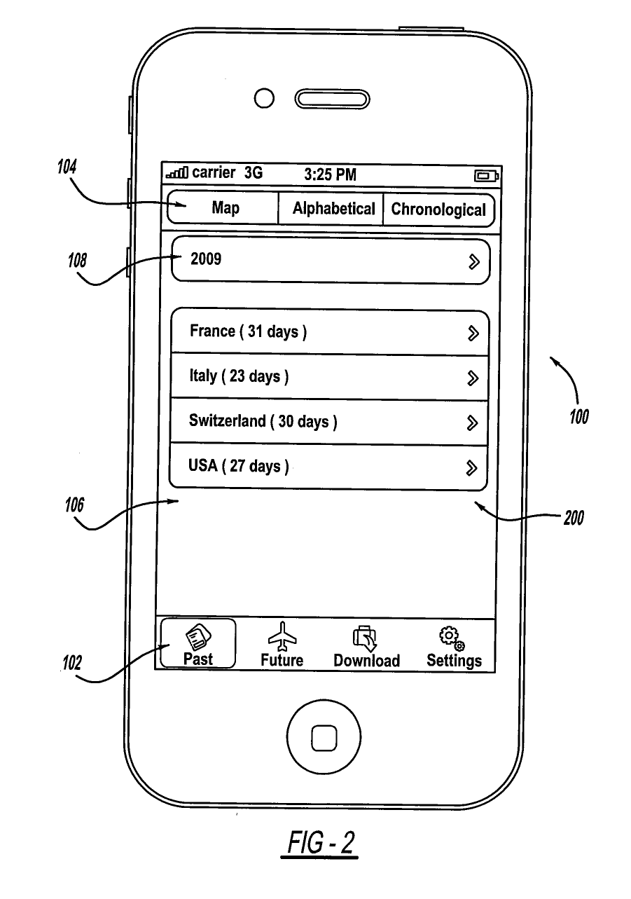

FIG. 2 is a screenshot of a page 200 displaying the graphical user interface 100 with the “Past” option selected in the menu bar 102 and the “Alphabetical” option selected in the display option toolbar 104 (i.e., a past alphabetical view) in the system for determining a tax liability trigger. The selected selectable year in the year input field 108 is 2009. With the “Alphabetical” option selected in the display option toolbar 104, the display area 106 may display a textual representation 202 of the one or more (e.g., four) countries the user was located in during the selected selectable year and the corresponding number of tracked days. The display area 106 may display as a list textual representations 202 of some or all of the one or more countries the user was located in during the selected selectable year, for example in alphabetical order. The number of tracked days may be displayed next to the corresponding textual representations 202 (e.g., in parentheticals), for example. For example, as shown in FIG. 2, the user was located in France on 31 days, in Italy on 23 days, in Switzerland on 30 days and in the United States on 27 days in 2009.

In some implementations (not pictured), the “Past” option may be selected in the menu bar 102 and the “Chronological” option may be selected in the display option toolbar 104 (i.e., a past chronological view) in the system for determining a tax liability trigger. With the “Chronological” option selected in the display option toolbar 104, the display area 106 may display a textual representation 202 of the one or more countries the user was located in during the selected selectable year and the corresponding number of tracked days. The display area 106 may show textual representations 202 of some or all of the one or more countries the user was located in during the selected selectable year, listed in chronological order, for example. In some implementations, the listing of the one or more countries may be chronologically ordered according to first date visited, last date visited, or any other chronological criteria. The number of tracked days may be displayed next to the corresponding textual representations 202 (e.g., in parentheticals), for example.

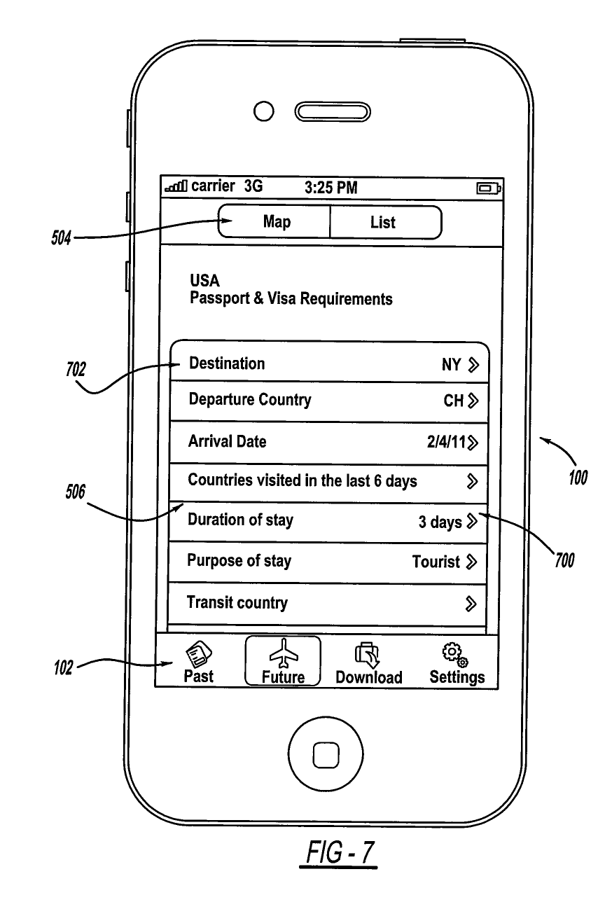

If one of the “Alphabetical,” “Chronological”, or “List” options of the display options toolbar 104 is currently selected, the user may select one of the textual representations 202 of a country, for example “France,” to display additional data relating to the number of tracked days, which will be shown in FIG. 7.

FIG. 3 is a screenshot of a page 300 displaying the graphical user interface 100 after one textual representation 202 or text box 112 was selected on the page 200. After the user selects the one textual representation 202 (e.g., “France”), the display area 106 may display one or more consecutive date ranges 302 (e.g., three date ranges 302) the user was present in the country corresponding to the textual representation 202, and may display the corresponding number of days in each of the one or more consecutive date ranges 302. In some implementations, the one or more consecutive date ranges 302 may be in chronological order (i.e., chronological order view). For example, as shown in FIG. 3, the user was located in France on 18 days between Jan. 5, 2009 and Jan. 23, 2009, on 2 days between Mar. 7, 2009 and Mar. 9, 2009, and on 11 days between May 14, 2009 and May 24, 2009. The number of tracked days for France (e.g., 31 days) may also be displayed in the display area 106. The user may select a consecutive date range 302 such as “Jan 5-23-2009 (18 days),” for example, to manually change or remove (e.g. override) the selected consecutive date range 302. This may be desirable, for example, if the mobile device was turned off for a prolonged period and didn't properly record the location.

The user may manually change or remove the selected consecutive date range 302 because in the United States, for example, there are exceptions to the general rule that the user is treated as present in the United States on any day the user is physically present in the country, at any time during the day. For example, the user is not considered present in the United States for the substantial presence test during days: (1) the user commutes to work in the United States from a residence in Canada or Mexico, if the user regularly commutes from Canada or Mexico; (2) the user is in the United States for less than 24 hours, when the user is in transit between two places outside the United States; (3) the user is in the United States as a crew member of a foreign vessel; (4) the user is unable to leave the United States because of a medical condition that develops while the user is in the United States; and the user is an exempt individual.

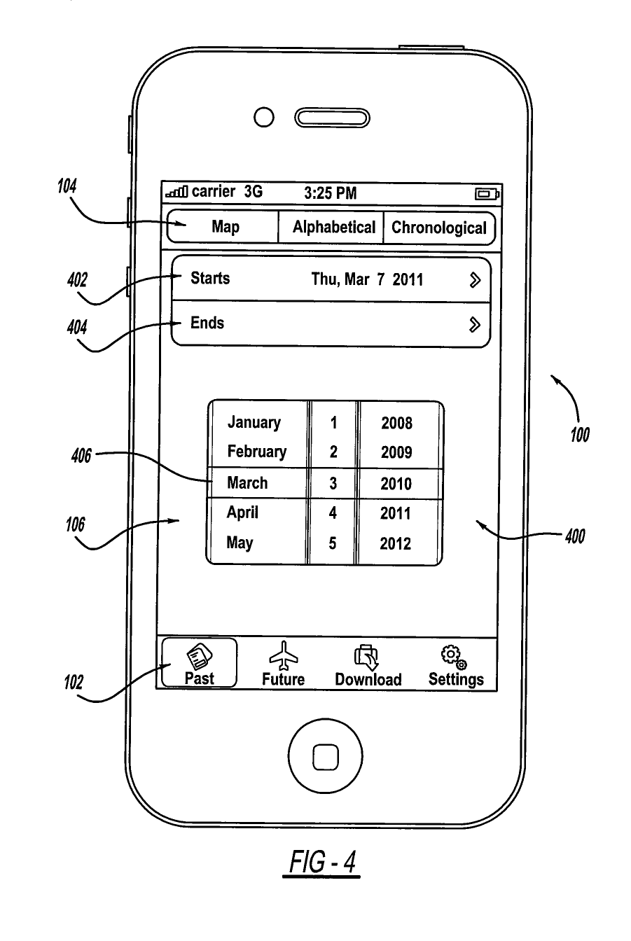

FIG. 4 is a screenshot of a page 400 displaying the graphical user interface 100 after a consecutive date range 302 was selected on the page 300. After the user selects the consecutive date range 302 (e.g., “Jan 5-23-2009 (18 days)”), the graphical user interface 100 may include a start date input field 402 and an end date input field 404. Using the start date input field 402 and the end date input field 404, the user may change or remove the selected consecutive date range 302 representing some or all of the days the user was present in France in 2009, for example, as shown in FIG. 4. In the implementation shown in FIG. 4, a date wheel 406 may be displayed in the display area 106 after the user selects the start date input field 402 or the end date input field 404. The user may change the day, the month and/or the year in the start date input field 402 and/or the end date input field 404. In other implementations, the user may input text into the start date input field 402 and/or the end date input field 404. In yet other implementations, the start date input field 402 and/or the end date input field 404 may be drop down menus.

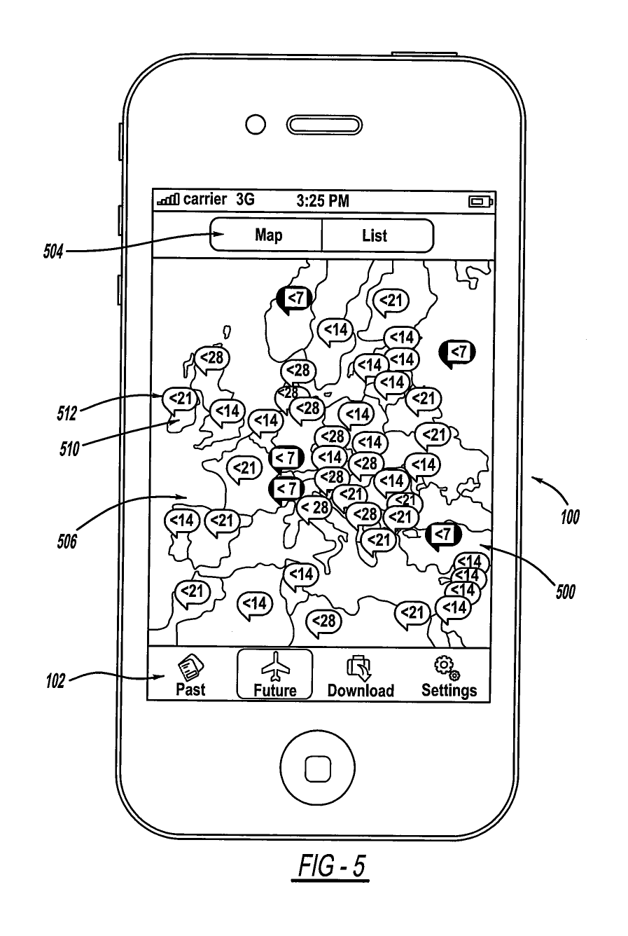

FIG. 5 is a screenshot of a page 500 displaying the graphical user interface 100, which includes the menu bar 102, a display options toolbar 504 and/or a display area 506 that includes map representations 510 and text boxes 512. FIG. 5 shows the “Future” option selected in the menu bar 102 and the “Map” option selected in the display option toolbar 504 in the system for determining a tax liability trigger. When the “Future” option is selected in the menu bar 102, the display area 506 may display data representing the number of days before a tax liability trigger occurs in each of one or more countries.

After the user selects the “Future” option in the menu bar 102, the selection in the display options toolbar 104 may determine how the data representing the number of days before the tax liability trigger occurs in each of one or more countries is displayed. For example, the options in the display options toolbar 504 may include “Map,” “Alphabetical,” “Chronological,” “List,” or a combination thereof. When the “Map” option is selected in the display options toolbar 504, as shown in FIG. 5, the display area 506 may display a map representation 510 of the one or more countries and the corresponding data representing the number of days before the tax liability trigger occurs in each of the one or more countries. The number of days before the tax liability trigger may be calculated using and based on the tracked number of days and the tax information of the user of the mobile device. For example, the number of days before the tax liability trigger occurs may be calculated by subtracting the tracked number of days from a predetermined maximum number of tracked days for the country. The predetermined maximum number of tracked days may be based on the tax information relating to the country, which may include information relating to a maximum number of days an individual can stay in a country before being subject to taxation.

The location information may be received from the global positioning system or the user input device. The display area 506 may show a map of a region (e.g., Europe) of the world or a map of the entire world. An interpretation of the number of days before the tax liability trigger may be displayed in the display area 506 in text boxes 512 placed in or pointing to the map representations 510 of some or all of the one or more countries.

In some implementations, the text boxes 512 for each of the one or more countries may display less than a certain increment of days remaining before the tax liability trigger. For example, the increment may be one month, or as shown in FIG. 5, one week. If the increment is one week and if the number of days before the tax liability trigger for a country is equal to 12, then the corresponding text box 512 for that country may display “<13 days.” If less than the lowest increment of days remains before a tax liability trigger for a country, then the corresponding text box 512 may be highlighted. For example, as shown in FIG. 5, if the increment is one week and if less than a week remains before a tax liability trigger for a country, then the corresponding text box 512 may display “<7 days” and may be highlighted. In other implementations (not pictured), the text boxes 512 for each of the one or more countries may list the number of days before the tax liability trigger as exact numbers. For example, if 12 days remain before the tax liability trigger in a country, then the text box 512 may display “12.” Tax information relating to the one or more countries may be utilized to adjust the value of the number of days before the tax liability trigger.

In some implementations, if the number of days before the tax liability trigger for a particular country equals zero, then the graphical user interface 100 may display an alert informing the user of a tax liability trigger. The alert may be a text notification, a graphical notification, a sound notification, and/or a combination thereof.

If the “Map” option of the display options toolbar 504 is currently selected, the user may select one of the text boxes 512 corresponding to a country, for example “USA,” to display one or more passport and/or visa requirements data, which will be shown in FIG. 7.

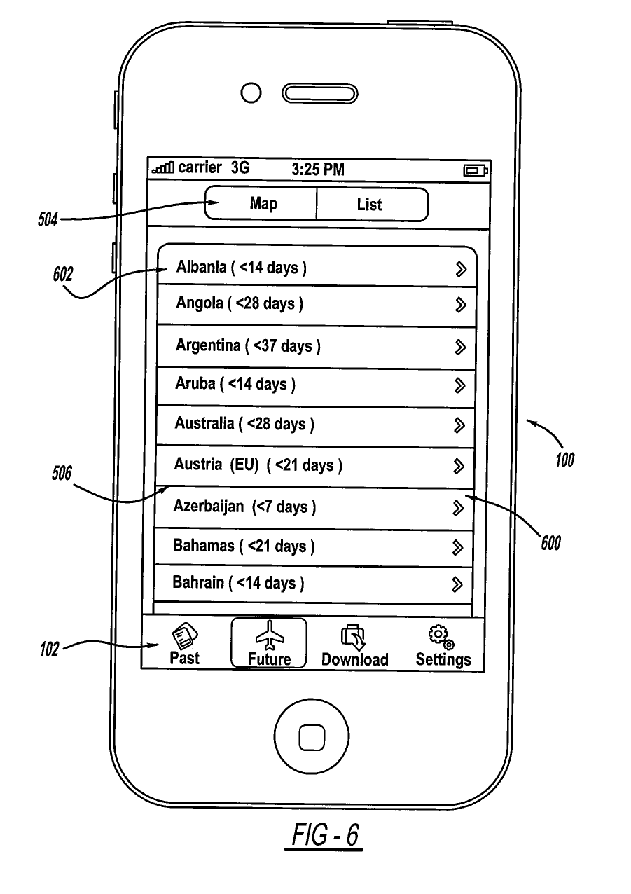

FIG. 6 is a screenshot of a page 600 displaying the graphical user interface 100 with the “Future” option selected in the menu bar 102 and the “List” option selected in the display option toolbar 504 (i.e., a list view) in the system for determining a tax liability trigger. With the “List” option selected in the display option toolbar 504, the display area 506 may display a textual representation 602 of one or more countries, in alphabetical order, for example. The one or more countries listed may include all countries in the world, countries in a particular reason, countries the user has already visited, or countries the user has selected to list. In some implementations, next to each of the one or more countries, the display area 506 may display less than a certain increment of days remaining before the tax liability trigger, in a way similar to FIG. 5. For example, as shown in FIG. 6, less than 14 days remain before a tax liability trigger in Albania, and less than 28 days remain before a tax liability trigger in Angola, etc. In other implementations (not pictured), the number of days before the tax liability trigger may be displayed as an exact number next to the corresponding textual representations 602 (e.g., in parentheticals). For example, if 12 days remain before a tax liability trigger in Albania, then the display area 506 may display “12” next to the textual representation 602 of Albania.

If one of the “Alphabetical,” “Chronological”, or “List” options of the display options toolbar 504 is currently selected, the user may select one of the textual representations 702 of a country, for example “USA,” to display one or more passport and/or visa requirements data, which will be shown in FIG. 7.

FIG. 7 is a screenshot of a page 700 displaying the graphical user interface 100 after one textual representation 602 was selected on the page 600. After the user selects the one textual representation 602 (e.g., “USA”), the display area 506 may display one or more passport and/or visa requirements data 702 for the country corresponding to the selected textual representation 602 (e.g., “USA”). The passport and/or visa requirements data 702 may include, for example, fields including a destination in the selected country (e.g., “NY”), a departure country from which the user has traveled to the selected country (e.g. “CH”), an arrival date in the selected country (e.g. “2/4/11”), countries visited in the last 6 days, duration of stay in the selected country (e.g. “3 days”), the purpose of the stay (e.g. “Tourist”), and a transit country through which the user has traveled to the selected country. All aspects of the passport and/or visa requirements data 702 may be manually or automatically incorporated into calculations of the number of tracked days and the number of days before the tax liability trigger. The user may select any of the fields of the passport and/or visa requirement data 702 to view further details.

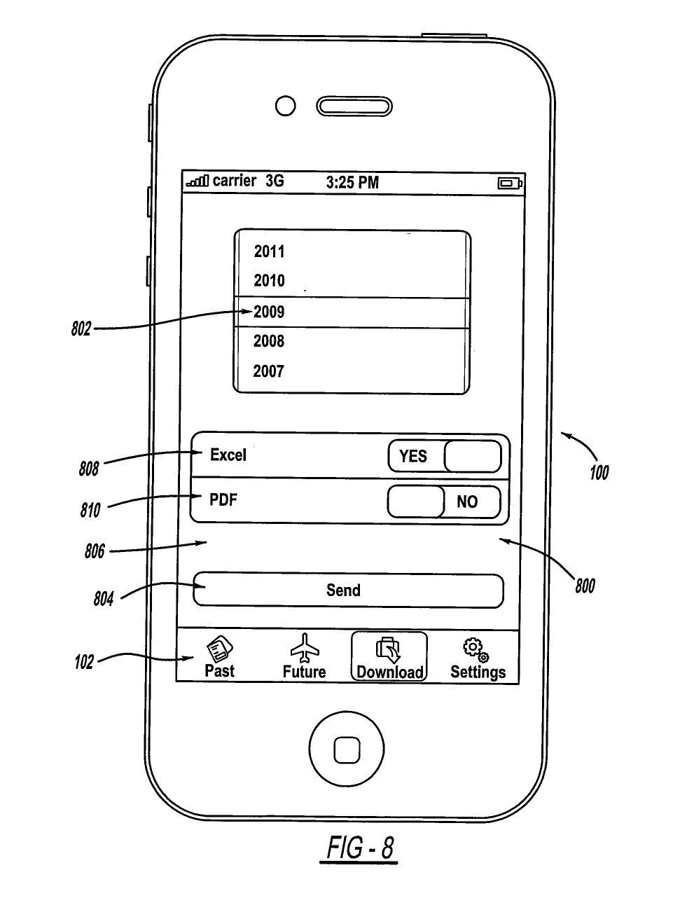

FIG. 8 is a screenshot of a page 800 displaying the graphical user interface 100 having the menu bar 102, and a display area 806 that includes a date wheel 802, and a send button 804, an Excel selection field 808, and/or a PDF selection field 810. FIG. 8 shows the “Download” option selected in the menu bar 102 in the system for determining a tax liability trigger. When the “Download” option is selected in the menu bar 102, the display area 106 may display options for exporting the tracked number of days and/or the number of days before the tax liability trigger to an external computing device

The date wheel 802 may contain a list of current years (e.g. 2011), previous years (e.g. 2010), and combinations thereof (e.g. 2011 and 2010, or 2010 and 2009). By scrolling through the date wheel 802, the user may select a year or a combination of years from which an exportable tracked number of days and/or number of days before the tax liability trigger to an external computing device data is desired. The user may use the Excel selection field 808 to choose whether to export an Excel version of the tax liability trigger data by selecting either “Yes” or “No,” and/or use the PDF selection field 810 to choose whether to export a PDF version of the tax liability trigger data by selecting either “Yes” or “No.” In other implementations, the display area may also provide selection fields for other formats, for example Word and HTML formats. After the user completes selections on the date wheel 802, Excel selection field 808, and PDF selection 808, the user may press the send button 804 to export the tracked number of days and/or the number of days before the tax liability trigger to an external computing device. The external computing device may be a personal computer, mobile device, personal data assistant, or portable music player, for example. The tracked number of days and/or the number of days before the tax liability trigger may be sent in an e-mail, through a Bluetooth connection, or by any other transmission method known in the art.

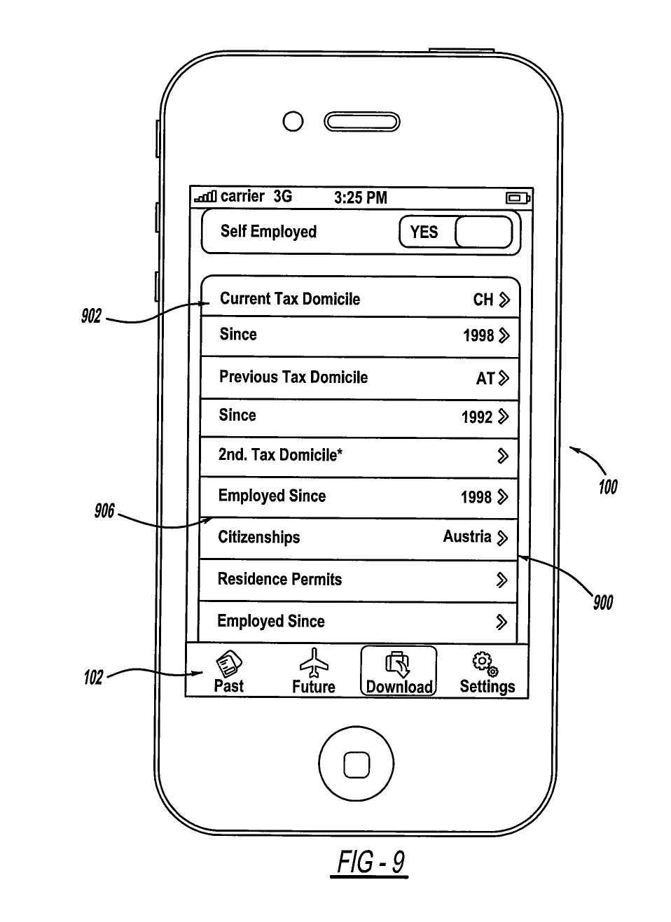

FIG. 9 is a screenshot of a page 900 displaying the graphical user interface 100, which includes the menu bar 102 and/or a display area 906 that includes user tax data 902. FIG. 9 shows the “Settings” option selected in the menu bar 102 in the system for determining a tax liability trigger. When the “Settings” option is selected in the menu bar 102, the display area 906 may display settings for changing the user tax 902.

The display area 906 may display travel user tax data 902 that includes, for example, whether the user is self employed (e.g. “Yes”), the user's current tax domicile (e.g. “CH”), how long the user has been domiciled in the current tax domicile (e.g. since “1998”), the user's previous tax domicile (e.g. “AT”), how long the user was domiciled in the previous tax domicile (e.g. since “1992), the user's 2nd tax domicile, how long the user has been employed (e.g. since “1998), the user's citizenships (e.g. “Austria”), the user's residence permits. All aspects of the user tax data 902 may be manually or automatically incorporated into calculations of the number of tracked days and number of days before the tax liability trigger. The user may select any of the fields of the user tax data 902 to view further details.

FIG. 10 is a block diagram of a mobile device 1000 of an embodiment. The mobile device 1000 may include a set of instructions 1016 that may be executed to cause the mobile device 1000 to perform any one or more of the methods or computer based functions disclosed herein. The mobile device 1000 may operate as a standalone device or may be connected, for example, using a network 1050, to other computer systems or peripheral devices.

In a networked deployment, the mobile device 1000 may operate in the capacity of a server or as a client user computer in a server-client user network environment, or as a peer computer system in a peer-to-peer (or distributed) network environment. The mobile device 1000 may also take the form of a personal computer (PC), a tablet PC, a personal digital assistant (PDA), a palmtop computer, a laptop computer, a communications device, a wireless telephone, a pager, or any other machine capable of executing a set of instructions 1016 (sequential or otherwise) that specify actions to be taken by that machine. In a particular implementation, the mobile device 1000 may be implemented using electronic devices that provide voice, video or data communication. In other embodiments, the functionality discussed herein is implemented in a desktop or less mobile device. In such systems, the components shown in this diagram may be distributed to multiple components.

As illustrated in FIG. 10, the mobile device 1000 may include a processor 1002 such as a central processing unit (CPU), a graphics processing unit (GPU), or both. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The mobile device 1000 may include a memory 1004 that may communicate via a bus 1006. The memory 1004 may be a main memory, a static memory, or a dynamic memory. The memory 1004 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1004 may include a cache or random access memory for the processor 1002.

Alternatively, the memory 1004 may be separate from the processor 1002, such as a cache memory of a processor, the system memory, or other memory. The memory 1004 may be an external storage device or database for storing data. Examples may include a hard drive, a compact disc (“CD”), digital video disc (“DVD”), memory card, memory stick, floppy disc, universal serial bus (“USB”) memory device, or any other device operative to store data. The memory 1004 may be operable to store instructions 1016 executable by the processor 1002. The functions, acts or tasks illustrated in the figures or described herein may be performed by the programmed processor 1002 executing the instructions 1016 stored in the memory 1004. The functions, acts or tasks may be independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

The mobile device 1000 may include a display 1008 such as a liquid crystal display (LCD), an organic light emitting diode (OLED), a flat panel display, a solid state display, a cathode ray tube (CRT), or other now known or later developed display device for outputting determined information. The display 1008 may act as an interface for the user to see the functioning of the processor 1002, or specifically as an interface with the software stored in the memory 1004.

The mobile device 1000 may also include an input device 1010 configured to allow a user to interact with any of the components of the mobile device 1000. The input device 1010 may be a cursor control device such as a touch screen display, a mouse, a joystick, or a remote control, a keyboard, a number pad, or any other device operative to interact with the mobile device 1000.

The mobile device 1000 may include a disk or optical drive unit 1012. The disk drive unit 1012 may include a computer-readable medium 1014, in which one or more sets of instructions 1016 (e.g., software) may be embedded. The instructions 1016 may perform one or more of the methods or logic as described herein. The instructions 1016 may reside completely, or at least partially, within the memory 1004 and/or within the processor 1002 during execution by the mobile device 1000. The memory 1004 and the processor 1002 also may include computer-readable media as discussed above.

The mobile device 1000 may include a global positioning system 1020. The global positioning system 1020 may receive location information from a global positioning satellite and provide the location information to the other devices in the mobile device 1000.

The present disclosure contemplates a computer-readable medium 1014 that includes instructions 1016 or receives and executes instructions 1016 responsive to a propagated signal so that a device connected to the network 1050 may communicate data over the network 1050. The instructions 1016 may be transmitted or received over the network 1050 via a communication interface 1018. The communication interface 1018 may be a part of the processor or may be a separate component. The communication interface 1018 may be created in software or may be a physical connection in hardware. The communication interface 1018 may be configured to connect with the network 1050, external media, the display 1014, any other components in the mobile device 1000, or combinations thereof. The connection with the network 1050 may be established wirelessly or may be a physical connection, such as a wired Ethernet connection. Likewise, the additional connections with other components of the mobile device 1000 may be physical connections or may be established wirelessly.

The network 1050 may include wired networks, wireless networks, or combinations thereof. The wireless network may be a cellular telephone network, an 802.11, 802.16, 802.20, or WiMax network. The network 1050 may be a public network, such as the Internet, a private network, such as an intranet, or combinations thereof. The network 1050 may utilize a variety of networking protocols now available or later developed including, but not limited to TCP/IP based networking protocols.

The computer-readable medium 1014 may be a single medium, or the computer-readable medium 1014 may be multiple media such as a centralized or distributed database and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer readable medium 1014 may include a solid-state memory such as a memory card or other package that houses one or more non-volatile read-only memories. The computer-readable medium 1014 also may be a random access memory or other volatile re-writable memory. Additionally, the computer readable medium 1014 may include a magneto-optical or optical medium such as a disk, tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer readable-medium or a distribution medium and other equivalents and successor media, in which data or instructions may be stored.

Alternatively, dedicated hardware implementations, such as application specific integrated circuits, programmable logic arrays and other hardware devices, may be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively, virtual computer system processing may be constructed to implement one or more of the methods or functionality as described herein.

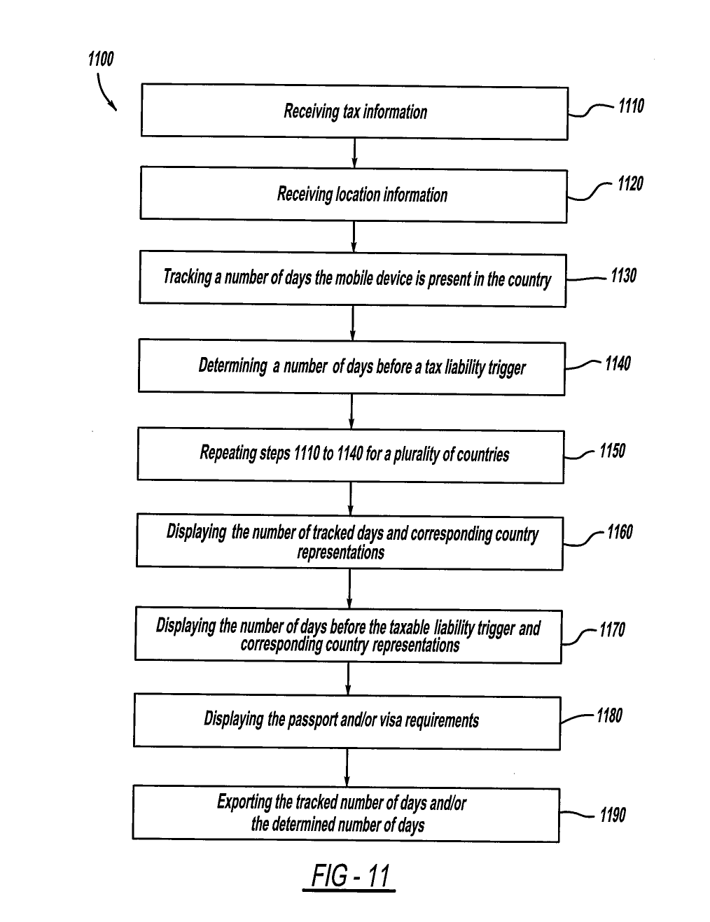

FIG. 11 illustrates a method 1100 for determining a number of days before the tax liability trigger. The following steps may be performed in a mobile device comprising a processor and a memory storing tax information of a user of the mobile device. The ordering of the steps presented herein is merely one implementation of the method 1100. Those skilled in the art will recognize that the ordering may be varied, that some steps may occur simultaneously, that some steps may be omitted, and that further steps may be added.

In block 1110, the tax information may be received from the user via a user input device of the mobile device. The method may proceed from block 1110 to block 1120.

In block 1120, the mobile device may receive location information identifying a country that the mobile device is present in. The location information may be received from a global positioning system of the mobile device or from a user input device of the mobile device, for example. The method may proceed from block 1120 to block 1130.

In block 1130, the processor tracks a number of days the mobile device is present in the country. The number of tracked days may be updated based on the location information received from a global positioning system or a user input device. For example, as a user travels in the one or more countries, the number of days the user was present in each of the one or more countries may be tracked and automatically updated using location information received from the global positioning system. The number of days the user was present in the one or more countries may also be tracked and manually updated using location information received from the user using the user input device. The number of tracked days may be also be adjusted based on country tax data that may determine which days count toward the number of tracked days and how much to weight each day when adding the day to the number of tracked days. In various implementations, the method may proceed from block 1130 to block 1140.

In block 1140, the processor may determine the number of days before the tax liability trigger occurs in the country based on the tracked number of days and the tax information of the user of the mobile device. For example, the processor may determine the number of days before the tax liability trigger occurs by subtracting the tracked number of days from a predetermined maximum number of tracked days for the country. The predetermined maximum number of tracked days may be based on the tax information relating to the country. The memory may store the days before tax liability trigger value. The method may proceed from block 1140 to block 1150.

In block 1150, the steps represented in blocks 1110 to 1140 may be repeated for a plurality of countries. The number of tracked days may be one of a plurality of number of tracked days corresponding to a plurality of countries. The number of days before the tax liability trigger may be one of a plurality of days before tax liability trigger values corresponding to a plurality of countries. The method may proceed from block 1150 to block 1160.

In block 1160, the plurality of the number of tracked days and representations of the plurality of corresponding countries may be displayed. The representations may be maps or textual representations. The textual representations may be displayed as a list, for example alphabetically or chronologically. The chronological listing may be based on dates visited in the plurality of corresponding countries. The method may proceed from block 1160 to block 1170.

In block 1170, the plurality of the number of days before tax liability trigger values and representations of the plurality of corresponding countries may be displayed. The representations may be maps or textual representations. The textual representations may be displayed as a list, for example alphabetically. The method may proceed from block 1170 to block 1180.

In block 1180, one or more of passport and/or visa requirements for the country may be displayed. The method may proceed from block 1180 to 1190.

In block 1190, the processor may generate spreadsheets or lists of the plurality of number of tracked days values and/or the plurality of days before tax liability trigger values, for example in Excel, Word, PDF, or HTML format. The spreadsheets or lists may then be exported to an external computing device, for example a personal computer, mobile device, personal data assistant, or portable music player, for example.

The illustrations described herein are intended to provide a general understanding of the structure of various implementations. The illustrations are not intended to serve as a complete description of all of the elements and features of apparatus, processors, and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific implementations have been illustrated and described herein, it should be appreciated that any subsequent arrangement designed to achieve the same or similar purpose may be substituted for the specific implementations shown. This disclosure is intended to cover any and all subsequent adaptations or variations of various implementations. Combinations of the above implementations, and other implementations not specifically described herein, may be apparent to those of skill in the art upon reviewing the description.

The abstract is provided with the understanding that it will not be used to interpret or limit the scope or meaning of the claims. In addition, in the foregoing Detailed Description, various features may be grouped together or described in a single implementation for the purpose of streamlining the disclosure. This disclosure is not to be interpreted as reflecting an intention that the claimed implementations require more features than are expressly recited in each claim. Rather, as the following claims reflect, inventive subject matter may be directed to less than all of the features of any of the disclosed implementations. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other implementations, which fall within the true spirit and scope of the description. Thus, to the maximum extent allowed by law, the scope is to be determined by the broadest permissible interpretation of the following claims and their equivalents, and shall not be restricted or limited by the foregoing detailed description.

What is claimed is:

1. A method for determining a number of days before a tax liability trigger, the method comprising:
performing the following steps in a mobile device comprising a processor and a memory storing tax information of a user of the mobile device:
receiving location information identifying a country that the mobile device is present in;
tracking a number of days the mobile device is present in the country;
determining a number of days before a tax liability trigger occurs in the country based on the tracked number of days and the tax information of the user of the mobile device; and
displaying the number of days before the tax liability trigger.

2. The method of claim 1, wherein the steps are repeated for a plurality of countries.

3. The method of claim 1 further comprising receiving the tax information from the user via a user input device of the mobile device.

4. The method of claim 1, wherein the location information is received from a global positioning system.

5. The method of claim 1, wherein the location information is received from a user input device of the mobile device.

6. The method of claim 1 further comprising displaying the number of days before the tax liability trigger in a map.

7. The method of claim 1 further comprising displaying the number of days before the tax liability trigger in a list.

8. The method of claim 1 further comprising displaying the tracked number of days.

9. The method of claim 1 further comprising displaying one or more of passport and/or visa requirements for the country.

10. The method of claim 1 further comprising exporting the tracked number of days and/or the determined number of days to an external computing device.

11. A mobile device comprising:
a memory configured to store tax information of a user of the mobile device;
a display; and
a processor in communication with the memory and the display, wherein the processor is configured to:
receive location information identifying a country that the mobile device is present in;
track a number of days the mobile device is present in the country;
determine a number of days before a tax liability trigger occurs in the country based on the tracked number of days and the tax information of the user of the mobile device; and
display the number of days before the tax liability trigger.

12. The mobile device of claim 11, wherein the processor is configured to repeat the steps for a plurality of countries.

13. The mobile device of claim 11, wherein the processor is configured to receive the tax information from the user via a user input device of the mobile device.

14. The mobile device of claim 11, wherein the location information is received from a global positioning system.

15. The mobile device of claim 11, wherein the location information is received from a user input device of the mobile device.

16. The mobile device of claim 11, wherein the processor is configured to display the number of days before the tax liability trigger in a map.

17. The mobile device of claim 11, wherein the processor is configured to display the number of days before the tax liability trigger in a list.

18. The mobile device of claim 11, wherein the processor is configured to display the tracked number of days.

19. The mobile device of claim 11, wherein the processor is configured to display passport and/or visa requirements for the country.

20. The mobile device of claim 11, wherein the processor is configured to export the tracked number of days and/or the determined number of days to an external computing device.
